(19) United States
(12) Patent Application Publication
(10) Pub. No.: US 2017/0093105 A1
(43) Pub. Date: Mar. 30, 2017

(54) SYSTEMS AND METHODS FOR SMART CONNECTION, COMMUNICATION, AND POWER CONVERSION

(71) Applicant: CNRY INC., San Francisco, CA (US)

(72) Inventors: Mark Belinksky, San Francisco, CA (US); Justin Alvey, San Francisco, CA (US)

(21) Appl. No.: 15/143,304

(22) Filed: Apr. 29, 2016

Related U.S. Application Data
(60) Provisional application No. 62/156,133, filed on May 1, 2015.

(51) Int. Cl. H01R 31/06; H04Q 9/00; H02J 13/00; H01R 13/66; H02J 4/00

(52) U.S. Cl. CPC H01R 31/065; H01R 13/6675; H01R 13/6683; H01R 13/6691; H02J 4/00; H02J 13/00; H04Q 9/00

(57) ABSTRACT

Provided herein are systems and methods for an adapter that can convert building communication and high-voltage electrical systems to a low-voltage connection, communication, and power bus. The adapter can connect to and continuously power home and building electrical devices. The adapter can continuously monitor an environment using a plurality of sensors. The adapter can record one or more sensor measurements and make the measurements available to a user through a server-based platform over radio frequency communication. The adapter can be controlled and control connected devices through commands sent through radio frequency communication.

### CROSS-REFERENCE

This application claims the benefit of U.S. Provisional Application No. 62/156,133, filed May 1, 2015, which application is entirely incorporated herein by reference.

### BACKGROUND

Homes and buildings have electrical and communication wiring connected to devices such as smoke alarms, CO alarms, heat detectors, motion detectors, thermostats, lights and more. Currently these devices are directly wired into the AC power. There is no standard adapter to connect devices to the electrical system. This can be a danger and an electrical hazard. It can also prevent easily adding internet connectivity to existing devices, thus preventing the occupant and/or owner from learning about and/or controlling the status of the environment.

In electronics architecture, a bus is a communication system that transfers data between components inside a computing device, or between computers. It covers all related hardware components (optical fiber, wire, etc.) and software, including communication protocols. There is no means by which electrical and communication wiring can be converted into a communication system to be understood by a computing device over a bus.

### SUMMARY

A need exists for an adapter that can convert AC current into voltage that can directly power a connected device and that can convert communication wiring into signals that the device can read from and write to. An adapter capable of powering and communicating with devices attached to home and building electrical systems is described herein. The device can connect to and convert a power source from 120V and/or 230V AC into between 3V-5V of DC power. This can provide a continuous stream of power in order to keep a device it is connected to operational.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows an adapter.

FIG. 2 shows a schematic of direct connectivity of an AC to USB adapter.

FIG. 3 show a schematic of direct connectivity of an AC to AC adapter.

FIG. 4 shows a schematic of direct connectivity of an Ethernet to USB adapter with a power line.

FIG. 5 shows a schematic of a direct connectivity of a USB Wall Adapter.

FIG. 6 shows a schematic of a direct connectivity of an AC to USB adapter hub.

FIG. 7 shows possible functions of an adapter.

FIG. 8 shows possible connectivity and components in a communication system associated with an adapter.

FIG. 9 shows functions of the inputs to a real-time energy assessment by an adapter.

FIGS. 10A, 10B, 10C show graphical interpretation of sensor data that may be displayed on a user interface on a computer device in communication with an adapter

FIG. 11 shows functions of the inputs to accessory control by an adapter.

FIG. 12 functions of alarm signaling—example: weather emergency.

FIG. 13 shows an exploded view of the components of an adapter.

FIG. 14 shows a mesh network between adapters connected to devices.

FIG. 15 shows a radius to designate persons who may and may not receive a notification by proximity to adapters.

FIG. 16 shows a detection of a hazard by an adapter and a subsequent response initiated by a server.

FIG. 17 shows a graphic of the overall system architecture.

FIG. 18 shows a computer system configured to control, transmit, and receive one or more sensor measurements associated with the adapter.

FIG. 19 shows an example of a space with a complete adapter communication network.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

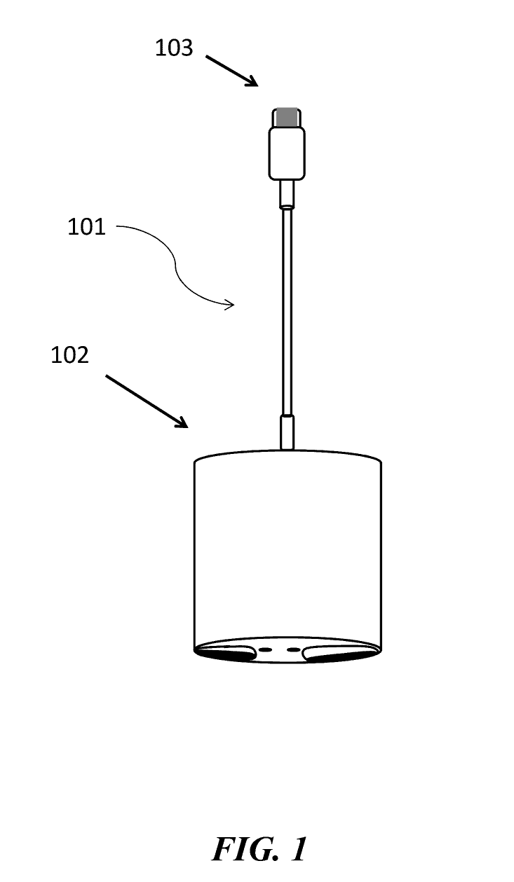

FIG. 1 shows a power adapter 101. The power adapter can have a smart connection, a communication port, and power bus to AC adapter. The power adapter can be housed in a plastic enclosure. One or more of connection modules, communication and power conversion tools including a transformer, electrolytic capacitors, diodes, MOSFET switching transistor, optocoupler, switcher, thermistor, bridge, bus connector, microprocessor, memory and printed circuit boards can be housed in the adapter. The adapter can be connected to one or more devices (such as a smoke alarm) using the appropriate cable. A device may not be a smart device. A device may not be configured to connect to a network. The adapter can permit the device to have a network connection. The adapter may be waterproof.

The adapter can have an input for an alarm interconnect cable. Life safety devices such as smoke alarms use an alarm interconnect cable (often the color red) that is wired through the home or building, connected to a fuse box, as a method to communicate with one another in the event of a fire emergency. Generally the cable is of the type NM cable 12-3 WG or NM-B 14/2 or 14/3.

The adapter can take the 9V DC (+/−2V) signal that is broadcast through the interconnect cable during an emergency such as a fire, or series of pulsing 9V DC (+/−2V) signals and convert it into a communication signal via our external supply. The adapter can perform signal processing with a signaling protocol processes that monitors power fluctuation from the interconnect cable, distinguishing it from other cables and other signals. The adapter can then broadcasts this information to the connected device via a cable such as USB to have the device broadcast the appropriate alert. This system also works in reverse such that the connected device can detect a condition and broadcast that through the adapter, which interprets the condition and broadcasts the state over the interconnect cable to other devices and the entire system.

The adapter can connect to devices using a removable external supply. In some case, such a cable may be Universal Serial Bus (USB) connector. USB connectors already allow users to connect devices such as a printer, mouse, strobe, manual alarm call point, fire alarm panel, headset, webcam, fingerprint scanner, VoIP phones, video phones, IP cameras, RFID reader, motion detector, keypad, building automation control, irrigation system, wireless access point, IPTV decoder, intercom, clock, lighting controller, point of sale kiosk, diagnostics device, billboard, personal healthcare device, power meter, mass storage, joystick, modem, ethernet adapter, microphone and multiple other devices. Most smartphones and many appliances include a USB connector. USB-C also adds audio, HDMI, UART & Mikey functionality to the adapter. The adapter can also have a non-removable external supply such as a USB connector.

The adapter can be installed in a space. The adapter can be connected in electrical communication with a power source, power line, and/or power consuming device in a space. The space can be an indoor space, and outdoor space, or a mixed indoor and outdoor space. The space can be a commercial or residential space. The space may be, for example, a home, apartment, a room, an interior of a vehicle, boat, airplane, yurt, shipping container, house, group of houses, or a building. The adapter can be installed in the space by a user. The adapter can be uninstalled in the space by a user. The adapter can be removably plugged into the power source, power line, and/or power consuming device in the space. The adapter can be repeatedly plugged into the power source, power line, and/or power consuming device in the space

In some cases, the adapter can comprise one or more sensors. At least a fraction of the one or more sensors can be on-board the adapter. At least a fraction of the one or more sensors can be contained in a housing of the adapter. In some cases at least a fraction of the one or more sensors can be off-board the adapter. The sensors off-board the adapter can be in wireless or wired communication with the sensor. The one or more sensors can be configured to measure one or more metrics in an environment surrounding the adapter. The one or more sensors can be configured to measure one or more metrics that describe an operating state of the detector. The one or more sensors can include one or more audio, vision, pressure, temperature, humidity, location (e.g. GPS), motion, inertial (e.g. accelerometer, magnetometer, or gyroscopic), organism, light, and/or Bluetooth sensors.

The adapter 101 may be configured to fit easily into a user's hand for easy installation and removal from a wall or ceiling, such as fitting inside a junction box. The adapter can have a size and weight such that the adapter can be held by a user with only one hand. The adapter can have a size and weight such that a user can install the adapter in a space without physical stress. The adapter can have similar dimensions to a typical USB Power Adapter, such that the adapter can fit into the footprint of a typical USB Power Adapter, a typical USB Power adapter can have a long dimension of about 1.1 inches and a thickness of about 1 inch. The adapter can have a circular cross section. The adapter may be square, rectangular, oval, or any other regular or irregular shape. The adapter may be sized and shaped such that the adapter can be mounted inside a wall or ceiling junction box of a building or onto a wall plug. The input head can be an oval with dimensions of about 0.33×0.1 inches.

The adapter can have a size and weight such that the adapter can be portable. The adapter can have a weight of about 1 gram (g), 5 g, 10 g, 15 g, 20 g, 25 g, 30 g, 35 g, 40 g, 45 g, 50 g, 55 g, 60 g, 65 g, 70 g, 80 g. 85 g, 90 g, 95 g, 100 g, 110 g, 120 g, 130 g, 140 g, 150 g, 160 g, 170 g, 180 g, 190 g, or 200 g. The adapter can have a weight less than 1 g. The adapter can have a weight greater than 200 g. The adapter can have a weight that is between any of the two values given above.

The adapter can have a total volume of at most about 100 cm³, 95 cm³, 90 cm³, 85 cm³, 80 cm³, 75 cm³, 70 cm³, 65 cm³, 60 cm³, 55 cm³, 50 cm³, 45 cm³, 40 cm³, 35 cm³, 30 cm³, 25 cm³, 20 cm³, 15 cm³, 10 cm³, 5 cm³, or 1 cm³. The adapter can have a volume less than 1 cm³. The adapter can have a volume greater than 100 cm³. The adapter can have a volume that is between any of the two values given above.

A body 102 of the adapter can have a shape that is roughly described by a rectangular prism, cylinder, or other three-dimensional shape. The body of the adapter can comprise a housing. The body of the adapter can have a length of at most about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The body of the adapter can have a length less than 5 mm. The body of the adapter can have a length greater than 500 mm. The body of the adapter can have a length that is between any of the two values given above. The body of the adapter can have a width of at most about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The body of the adapter can have a width less than 5 mm. The body of the adapter can have a width greater than 500 mm. The body of the adapter can have a length that is between any of the two values given above. The body of the adapter can have a height of at most about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The body of the adapter can have a height less than 5 mm. The body of the adapter can have a height greater than 500 mm. The body of the adapter can have a height that is between any of the two values given above. In the case of a cylindrical body of the adapter the body of the adapter can have a radius of at most about 500 mm, 400 mm, 300 mm, 200 mm, 250 mm, 100 mm, 95 mm, 90 mm, 85 mm, 80 mm, 75 mm, 70 mm, 65 mm, 60 mm, 55 mm, 50 mm, 45 mm, 40 mm, 35 mm, 30 mm, 25 mm, 20 mm, 15 mm, 10 mm, or 5 mm. The body of the adapter can have a radius less than 5 mm. The body of the adapter can have a radius greater than 500 mm. The body of the adapter can have a radius that is between any of the two values given above.

The adapter can configured to provide power conversion and/or signal processing for use by one or more other devices. In some cases, the adapter can provide a hub for broadcasting media, boosting cell phone reception, and/or repeating WiFi or other RF signals.

The adapter can be configured to convert power from alternating current (AC) to direct current (DC). The adapter can be installed in electrical communication with an AC power source. The adapter can be installed in electrical communication with a device that runs on DC power. The adapter can comprise a cable 103 configured to provide an electrical connection between the adapter and the device that runs on DC power. The adapter can convert power from the AC power source and supply the converted DC power to the device that runs on DC power. In some cases, the adapter can be configured to connect to an AC power source that provides power at about 10V, 20V, 30V, 40V, 50V, 60V, 70V, 80V, 90V, 100V, 110V, 120V, 130V, 140V, 150V, 160V, 170V, 180V, 190V, 200V, 210V, 220V, 230V, 240V, 250V, 300V, 350V, 400V, 450V, 500V, or 1000V. The adapter can convert power from the AC power supply to DC power at a power rating of about 1V, 2V, 3V, 4V, 5V, 10V, 20V, 30V, 40V, 50V, 60V, 70V, 80V, 90V, 100V, 200V, or 300V. The adapter can be configured to provide a continuous power supply to the device that runs on DC power. The adapter can provide a continuous stream of power to the device that runs on DC power such that the device is continually operational while the device is in electrical communication with the adapter. The adapter can be capable of providing power and/or network connectivity to devices installed in a residential or commercial space.

The adapter can receive measurement data from the one or more sensors. The adapter can receive the sensor data in a continuous stream or at discrete time intervals. The discrete time intervals can be consistently space throughout a day long period or the discrete time intervals can be non-uniformly distributed through a day long period. In some cases the discrete time interval can be shorter during the day such that sensor data is transmitted to the adapter more frequently during daytime hours. The adapter can have one or more processors programmed to collect, store, analyze, and/or broadcast the sensor data. The one or more processors can be on-board or off-board the adapter. In some cases, the sensor data can be stored locally on a memory storage device provided in the adapter. At least a portion of the sensor data can be stored on a memory storage device off-board the adapter. In some cases, the sensor data can be stored in a computer server that is in communication with the adapter.

In some cases, the sensor data can be a measurement of air composition of an environment in which an adapter may be installed. The sensor data may characterize the environment surrounding the adapter. The adapter may continuously monitor air composition in the environment. In some cases, the sensor data can be processed to determine if the sensor data indicates an alert condition. An alert condition can be a condition in which a safety, environmental, security, or other hazard condition is detected. In an example, an alert condition can occur when a toxic species (e.g., carbon monoxide, natural gas, or ozone) is detected in the environment. An alert condition can occur when a particulate concentration and/or particulate volume fraction exceeds a predetermined threshold. An alert condition can occur when heat and/or smoke is detected in the environment. The sensor data can continuously monitor air conditions in the environment surrounding the sensor regardless of the alert condition. The sensor data can continuously monitor air conditions in the environment surrounding the sensor during alert and non-alert conditions. The adapter can store sensor data locally on a memory storage device of the adapter. The adapter can transmit environmental measurements collected by the one or more sensors to a server or other storage device off board the adapter.

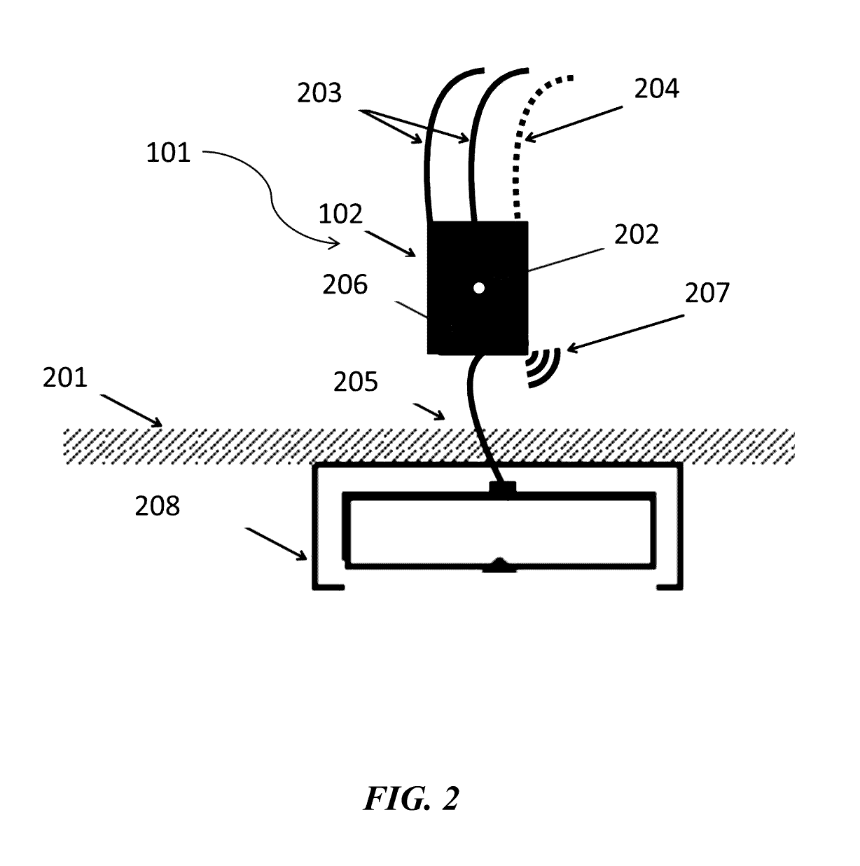

FIG. 2 shows an adapter 101 installed inside of a support. The adapter can be installed inside of a support 201 such that the adapter is not visible to a user during use. In some cases, the support can be a support structure in a building. The support can be a wall, post, ceiling, floor, beam, panel, or other surface that is at least partially closed. In some cases a user cannot access the adapter installed inside of the support without damaging the support. In some cases the support can comprise an openable portion such that a user can access an installed adapter.

At least a portion of the adapter can be installed inside of or behind a support. In some cases a support can be place between the adapter and an open area such as a room. A cord can protrude through the support to permit communication between the adapter inside of or behind the support and a user on an opposite side of and/or outside of the support. The body 102 of the adapter can have a state indicator light 202. In some cases, the indicator light can be a light emitting diode (LED), incandescent bulb, fluorescent light, halogen light, or any other suitable light source. The indicator light can be capable of emitting light within a predetermined range of wavelengths. The indicator light can be capable of emitting one color of light. The indicator light can be capable of emitting more than one color of light. The indicator light can emit light in a range of wavelengths that contains light that is visible to humans. The indicator light can emit light in a range of wavelengths that contains light that is not visible to humans. The indicator light can emit light in different colors based on the state of the adapter (e.g., on/off, connectivity state, health). The indicator light can emit light in different colors based on one or more measurements provided by the one or more sensors.

In some cases, one or more wires 203 can extend from the body of the adapter. In some cases, the wires can be configured to transmit power to and/or from the adapter. The wires can be configured to permit transmission of AC and/or DC current. The wires can be capable of transmitting high currents. In some cases the wires can be capable of transmitting power at a current of at least about 1 Amp, 10 Amp, 20 Amp, 30 Amp, 40 Amp, 50 Amp, 60 Amp, 70 Amp, 80 Amp, 90 Amp, 100 Amp, 200 Amp, 300 Amp, 400 Amp, 500 Amp, or 1000 Amp. In some cases, the body of the adapter can further comprise a wire 204 configured to connect to an alarm.

The body of the adapter can have a connective element 205 that provides connection between the adapter and a device on an opposite side of the support. In some cases the connective element can permit a user to plug in a device 208 to the adapter. The device can be a device that comprises one or more sensors. The device can be a device configured to monitor one or more conditions of an environment. In an example, the device can be a smoke detector, carbon monoxide (CO) detector, gas sensor, home alarm system, thermostat, humidity sensor, light detector, or any other device configured to monitor one or more environment conditions. The connective element can be configured to plug in to the device through a USB, micro USB, mini USB, VGA, or any other connection. The connective element can provide a male connection or a female connection to the device. In some cases, the connective element can be interchangeable to permit connection to different types of devices configured to accept different plugs. When the device is connected to the adapter, the connection can permit the adapter to provide power to the device. When the device is connected to the adapter, the connection can permit transmission of data between the adapter and the device. When the device is connected to the adapter, the connection can permit the adapter to convert power from a power source and provide the converted power to the device.

In some cases, one or more sensors 206 can be contained in the housing of the body. In some cases one or more sensors can be outside of the housing of the body. The one or more sensors can be contained in the device connected to the adapter. The sensors can comprise sensors that are capable of measuring one or more metrics of the environment surrounding the adapter.

In some cases, the adapter can communicate with one or more devices wirelessly. The adapter can communicate with one or more devices by transmitting and/or receiving Radio Frequency (RF) signals. One or more Radio Frequency (RF) modules 207 can be provided inside of the adapter. The one or more RF modules can transmit signals to other devices. The one or more RF modules can receive RF signals from other devices.

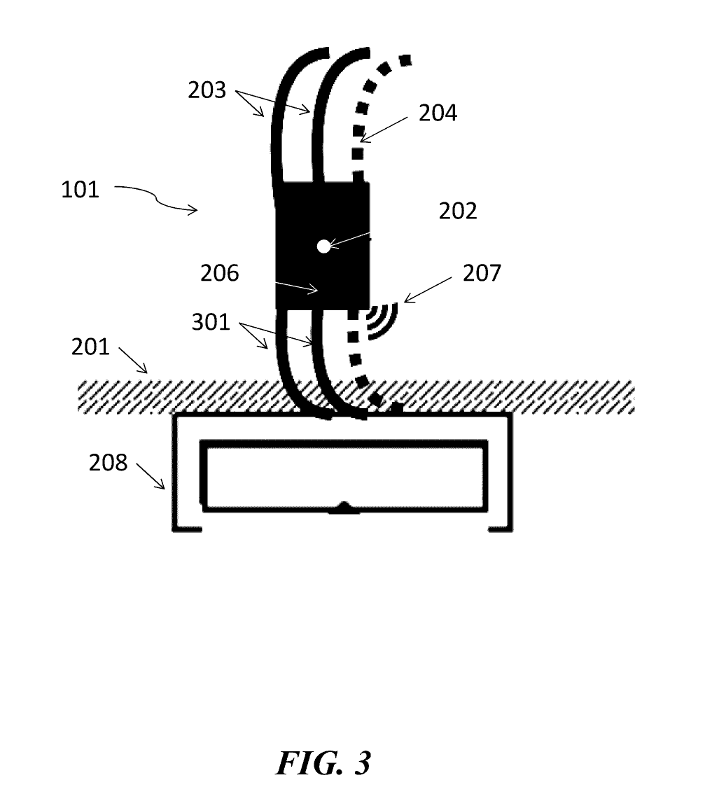

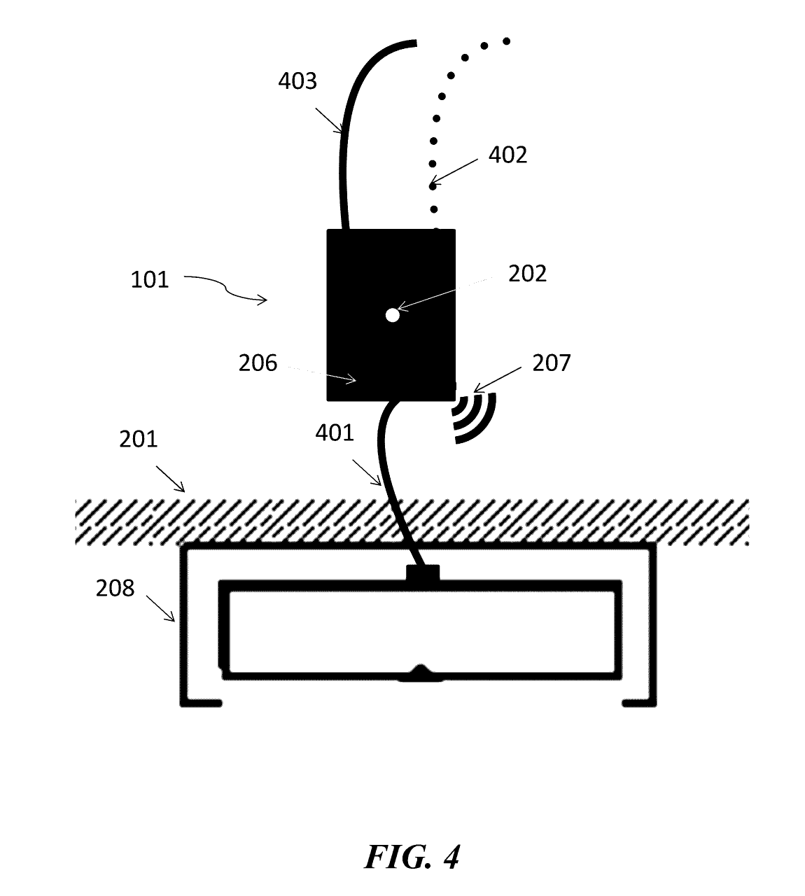

FIG. 3 shows an example of an adapter connected to a device through an AC wire 301 connection. FIG. 4 shows an example of an adapter connected to a device through a USB connection 401. The adapter can be connected to a power source through a power transmission line 403. The adapter can be connected to a network connection through a network connection cable 402.

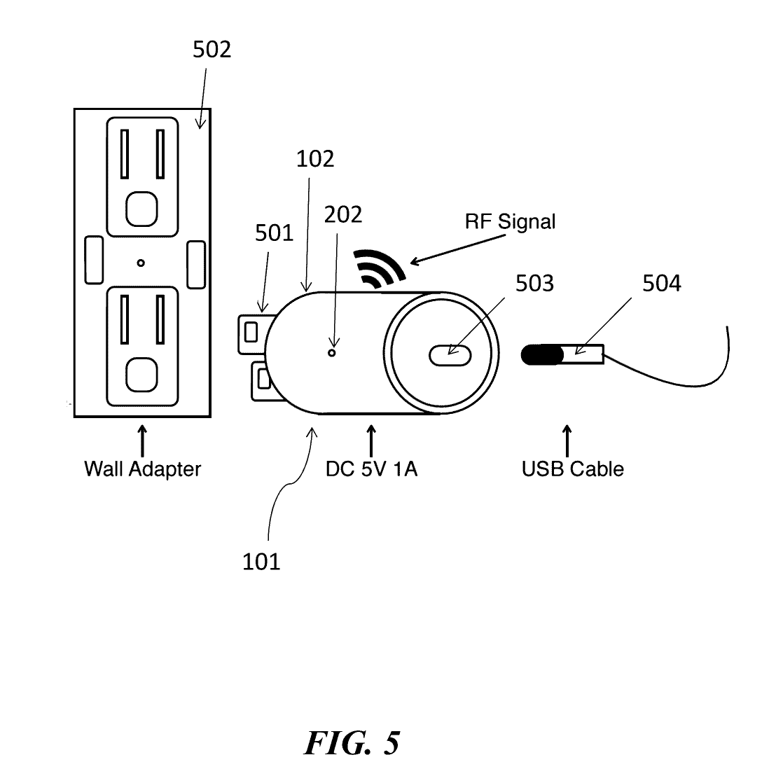

FIG. 5 shows an adapter 101 configured to plug into a wall outlet 502. A wall outlet can be a two-prong outlet. A wall outlet can be a grounded three-prong outlet. The adapter can comprise one or more prongs 501 configured to permit connection with the wall outlet. The prongs can be configured to connect to a standard wall outlet of one or more countries. In some cases the adapter can be transformed to provide one or more prongs with different shapes and/or orientations to plug into standard wall outlets of one or more countries. The adapter can be transformed by folding one or more prongs into or out of the adapter.

The body 102 of the adapter can have a state indicator light 202. In some cases, the indicator light can be a light emitting diode (LED), incandescent bulb, fluorescent light, halogen light, or any other suitable light source. The indicator light can be capable of emitting light within a predetermined range of wavelengths. The indicator light can be capable of emitting one color of light. The indicator light can be capable of emitting more than one color of light. The indicator light can emit light in a range of wavelengths that contains light that is visible to humans. The indicator light can emit light in a range of wavelengths that contains light that is not visible to humans. The indicator light can emit light in different colors based on the state of the adapter (e.g., on/off, connectivity state, health). The indicator light can emit light in different colors based on one or more measurements provided by the one or more sensors.

The adapter can have a connection bus 503. The adapter can have more than one connection bus. Each bus can have one or more ports into which different types of cables, for example USB cables, can be plugged in. The connection bus can permit one or more plug types to plug into the adapter. The adapter can convert power from a power source that transmits power through the wall outlet. The adapter can provide the converted power to one or more devices through the connection bus. In some cases, the connection bus can include a USB bus. A device can plug into the adapter connection bus through a cord 504, for example a USB cord.

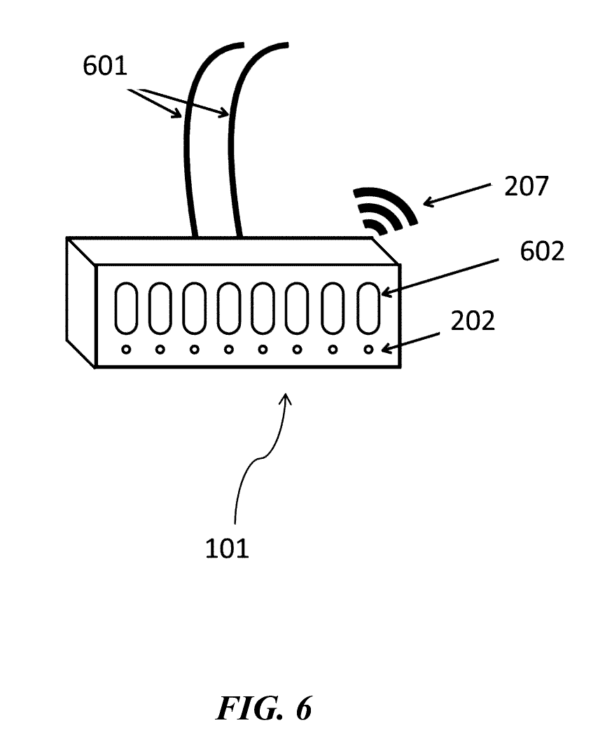

In some cases, the adapter may not be configured to plug into a wall outlet. FIG. 6 shows an adapter that does not connect to a power source through a wall outlet. The adapter 101 can connect directly to a power source. The power source can be an AC power source or a DC power source. The adapter can connect directly to a power source through one or more wires 601.

The adapter can have a connection bus with one or more ports 602 configured to accept a device plug in cable. Each of the ports can be configured to accept the same plug type. One or more of the plugs can be configured to accept a different plug type. In some cases, the adapter can have at least 1, 2, 3, 4, 5, 6, 7, 8, 9, 10, 20, 30, 40, 50, 60, 70, 80, 90, or 100 ports. The adapter can have more than 100 ports. The adapter can have a number of ports that falls between any of the values listed herein. At least one of the ports can have a device plugged in while the adapter is in use. The one or more ports can be grounded. Each of the ports can provide power with the same voltage and/or current. In some cases, at least one of the ports can provide power at a voltage and/or current that is different from a voltage and/or current of at least one of the other ports.

Each port can have an indicator light 202 that correspond to the port. The indicator light can turn on or off to display a state of the port. The indicator light can provide illumination in a specified color to indicate a state of the port. In some cases, the indicator light can be a light emitting diode (LED), incandescent bulb, fluorescent light, halogen light, or any other suitable light source. The indicator light can be capable of emitting light within a predetermined range of wavelengths. The indicator light can be capable of emitting one color of light. The indicator light can be capable of emitting more than one color of light. The indicator light can emit light in a range of wavelengths that contains light that is visible to humans. The indicator light can emit light in a range of wavelengths that contains light that is not visible to humans. The indicator light can emit light in different colors based on the state of the adapter (e.g., on/off, connectivity state, health). The indicator light can emit light in different colors based on one or more measurements provided by the one or more sensors.

In some cases, the adapter 101 can communicate with one or more devices wirelessly. The adapter can communication with one or more devices by transmitting and/or receiving RF signals. One or more RF modules 207 can be provided inside of the adapter. The one or more RF modules can transmit signals to other devices. The one or more RF modules can receive RF signals from other devices.

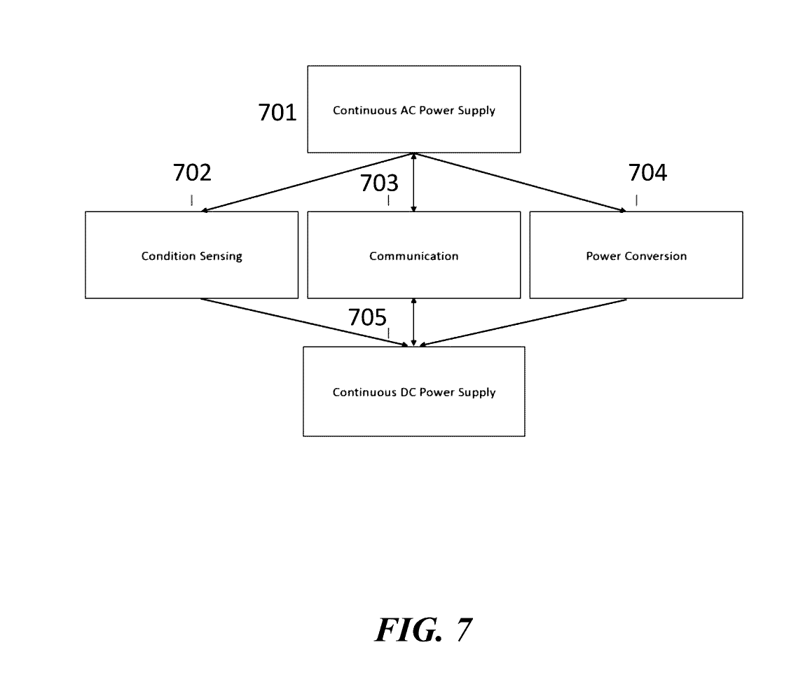

Power can be supplied to the adapter through a plug in and/or direct connection. The power supplied to the adapter can be utilized by the adapter to perform a plurality of functions. The adapter can perform two or more different functions simultaneously. FIG. 7 shows different functions that can be performed by the adapter using the power from a power supply that is provided in electrical communication with the adapter. Power 701 from the power supply can be applied to functions including detection and triggering of events. The power supply can be a continuous or discontinuous power supply. The power supply can be an AC or DC power supply.

In some cases at least a fraction of the power provided to the adapter can be used to operate one or more sensors 702. The one or more sensors can perform sensing of an environment. The one or more sensors can transmit data collected by the one or more sensors to one or more processors located on board and/or off board the adapter. The one or more processors can be programmed to interpret the sensor data to determine a condition of an environment surrounding the adapter. In some cases, a condition may be an event correlating with a sensor measurement that is expected to cause harm, damage, and/or benefit to a human, other organism (e.g., pet), and/or a building structure in an environment surrounding the adapter. The condition can include indoor as well as outdoor environmental conditions. In some cases, determination of a hazard condition can result in a warning state followed by an alarm state. When a warning state occurs a notification can be transmitted to a user or a group of users to confirm or deny a potential detected hazard. The notification can be displayed to a user on a display device such as a smart phone, television monitor, computer monitor, smart watch, or other display device. The notification can be an audio and/or visual notification. An alarm state may occur after a user or group of users has confirmed that the detected hazard is real (e.g. not a false alarm). In some cases the warning state may be skipped and only an alarm state may occur. For example, a hazard may be excessive moisture, humidity, temperature, fire, or earthquake. A hazard may otherwise indicate that a sensor measurement has exceeded a pre-set threshold. A pre-set threshold may be set by a user for one or more sensor measurements. A user may choose a pre-set threshold of a sensor value to correspond to conditions which may be hazardous to an environment. For example, an environment which may be more sensitive to moisture or humidity may have a lower threshold value for the moisture or water particles than an average environment.

In some cases at least a fraction of the power provided to the adapter can be used to operate one or more communication modules 703. The one or more communication modules can be configured to transmit and/or receive communication signals from other devices. The other devices can be in proximity of the adapter. The other devices can be plugged into the adapter. The other devices can communicate directly with the adapter. The other devices can communicate indirectly with the adapter by transmitting a communication signal or receiving a communication signal through a server. Communication can occur from the connection of an alarm interconnect wire. Communication may be a surge in electrical voltage (e.g., square wave). Surges may occur in patterns to communicate different information such as type and state of alarm. For example, a sustained 9V+/− surge of DC power can indicate the presence of a fire. Communication can be converted and broadcast over the bus to a connected device. Communication may work in reverse such that the connected device can detect a condition and broadcast through the adapter, which interprets the condition and broadcasts the state over the interconnect cable to other devices and the entire system.

In some cases at least a fraction of the power provided to the adapter can be converted from a first power type (e.g., signal, voltage, current) to a second power type 804. The adapter can be configured to convert power from alternating current (AC) to direct current (DC). The adapter can be installed in electrical communication with an AC power source. The adapter can be installed in electrical communication with a device that runs on DC power. The adapter can comprise a cable configured to provide an electrical connection between the adapter and the device that runs on DC power. The adapter can convert power from the AC power source and supply the converted DC power to the device that runs on DC power. In some cases, the adapter can be configured to connect to an AC power source that provides power at about 10V, 20V, 30V, 40V, 50V, 60V, 70V, 80V, 90V, 100V, 110V, 120V, 130V, 140V, 150V, 160V, 170V, 180V, 190V, 200V, 210V, 220V, 230V, 240V, 250V, 300V, 350V, 400V, 450V, 500V, or 1000V. The adapter can convert power from the AC power supply to DC power at a power rating of about 1V, 2V, 3V, 4V, 5V, 10V, 20V, 30V, 40V, 50V, 60V, 70V, 80V, 90V, 100V, 200V, or 300V. The adapter can be configured to provide a continuous power supply to the device that runs on DC power. The adapter can provide a continuous stream of power to the device that runs on DC power such that the device is continually operational while the device is in electrical communication with the adapter.

In some cases, the adapter can be provided as a continuous power supply 705. The adapter can provide continuous power to one or more devices. The adapter can simultaneously communicate with one or more devices while providing power to one or more devices. The devices in communication with the adapter can be the same devices in communication with the adapter. The devices in communication with the adapter can be the different devices from the devices in communication with the adapter.

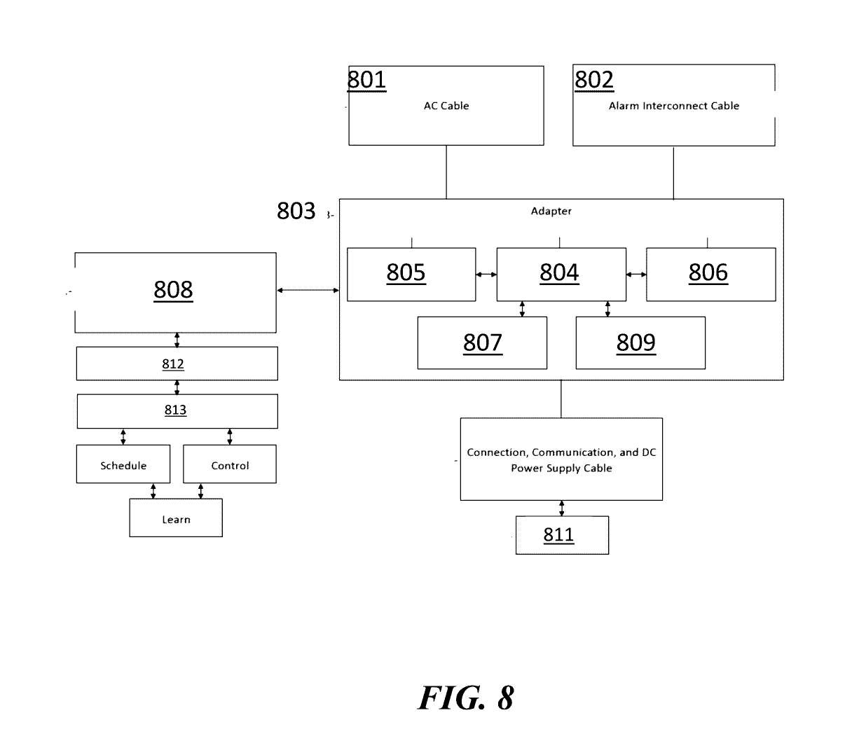

FIG. 8 shows a graphic describing an exemplary system architecture, demonstrating possible connectivity and components in a communication system associated with an adapter. One or more electrical transmission structures (e.g., AC cables) 801 can transmit power from a power source to the adapter. One or more communication transmission structures (e.g., alarm cables) 802 can transmit communication signals to and from the adapter 803. In some cases, transmission of power through the adapter can be controlled by a control system comprising one or more processors 804. A processor can be a microprocessor. The one or more processors can control a transmission rate, permissions, and/or other aspects of power transmission that can be regulated. The one or more processors can regulate a conversion of the power from a first type to a second type. The adapter can be configured to collect and store data. The data can be stored in a memory storage device 805. In some cases, the data can be data collected during the power conversion process. The data can comprise one or more measures of power consumption by one or more devices that are receiving power from the adapter. The data can comprise a log of communication between the adapter and one or more devices. In some cases, one or more sensors 806 can be provided in communication with the adapter. The one or more sensors can be on board or off board the adapter. The one or more sensors can transmit one or more measurements to the one or more processors. The sensor measurements can be stored in the memory storage device.

The storage device 805 can transmit one or more stored measurements from the sensors and/or from the data collected during power conversion. The measurements can be transmitted through one or more communication modules (e.g., radio frequency (RF) modules) 807 to a Hub, Central Controller, Smartphone, and/or Connected Device 808. The storage device 805 can transmit the measurements through a communication bus 809 to a Connection, Communication, and DC Power Supply Cable, which can then connect to a device 810.

When broadcasting through a Hub, Central Controller, Smartphone, Connected Device 808, measurements (e.g., information) can be passed back and forth through a local or virtual (internet) server 812. The server can receive one or more instructions from an automatic or manual processes executed by one or more processors through an application programming interface (API) 813. In some cases, the instructions can be scheduling and/or controlling instructions. Over time (e.g., repeated use) the adapter can learn about a user's preferences and/or use habits. The adapter can become more efficient and/or effective at recognizing alarm states by learning a user's preferences and/or use habits. The adapter can become more efficient and/or effective at false alarms by learning a user's preferences and/or use habits. When a user repeats a common activity that causes one or more sensors to exceed a threshold the alarm can adjust to recognize this activity as normal and therefore not a cause for alarm. For example, a user can cook dinner between 7 pm and 9 pm on weekdays and cause a change in air quality that could be indicative of a house fire. Over time and repeated use the alarm can recognize that the change in air quality is a result of cooking rather than a house fire and the threshold sensor value in this time period can be adjusted to reduce false alarms.

The adapter can be in communication with other adapters installed in a space. The adapter can be in communication with other adapters installed in the space through a wireless or wired connection. One or more adapters can be installed in a common space, for example a household, building, or building complex.

In addition to or instead of communicating with other adapters, each adapter can also communicate with one or more other devices. A device can be a device comprising one or more sensors. A device can be a smoke detector, carbon monoxide (CO) detector, gas sensor, home alarm system, thermostat, sprinkler bed, humidity sensor, light detector, motion detector inside or outside of a space, humidifier, fan, lights, leak detectors, or any other device configured to monitor and/or regulate one or more environment conditions. The adapter may communicate with one or more devices wirelessly or through a wired connection.

One or more of the adapters can be in communication with one or more sensors on board an electronic device, for example a pressure or humidity sensor, fingerprint scanner, and facial recognition on a smart phone. Two or more adapters in communication with each other can form a mesh to monitor one or more conditions (e.g., states) across a large space and/or many rooms. The adapters or a mesh of adapters can be in communication with an electronic device. The electronic device can be an electronic device comprising a display. The electronic device can provide a graphical user interface to a user on the display. The electronic device can be a smartphone, game system, television, tablet, laptop, desktop, other mobile personal computers, electronic medical devices, and/or wearable technology (e.g. smart watches or smart glasses). One or more of the adapters can communicate with the electronic device over a suitable network connection. The adapters can have a communication module with a transceiver configured to establish a connection to one or more home WiFi networks. The transceiver may be a IEEE 802.11 transceiver for establishing a network connection to connect to one or more home WiFi networks to connect to the internet and local electronic devices. The transceiver may be a CDMA/GSM/3G/4G/WiMax etc. Chipset transceiver for establishing in cases where cellular reception permits an alternative to the IEEE 802.11 connection, or other network connection, to enable an internet connection for sending data to the online server. The transceiver may alternatively be an IEEE 802.15 transceiver (e.g. Bluetooth, Zigbee, etc.) for communicating with other adapters and electronic devices. The adapter may communicate with the electronic devices through the established network connection for example a LAN, WAN, cloud, direct 1R, Bluetooth, or RF network. The adapter may also communicate with a server off board the adapter through the established network connection. Additionally, the adapter may access the internet through an established WiFi connection to obtain information about an environment in which the detector is installed in real time. Information about an environment may include local events, weather forecasts and emergencies, seasonal averages for temperature and humidity, traffic patterns, irrigation information, gas information, air quality forecasts, UV forecasts, current measured UV intensity, atmospheric pressure, reports of nearby fires, reports of nearby crimes, reports of nearby disease outbreaks, and/or city planning schedules (e.g. construction schedules, street cleaning). Alternatively information about the environment may come from crowdsourcing. Information about an environment may also include characterization of typical air particulates. The transceiver may send an HTTP request over an internet gateway such as a WiFi router, send data to an electronic device, using a protocol such as Bluetooth, and having the device relay data to the server using its own internet connection, send data over a cellular network, and/or relay data to other adapters which may have a better means (e.g. stronger network connection, more battery charge) to send the data to the server.

The adapter may be in communication with one or more processors programmed to conduct an energy assessment. An energy assessment may be based on measurements from one or more of the sensors onboard the adapter. An energy assessment may be based on measurements from one or more of the sensors off board the detector. An energy assessment may be based on combined measurements from one or more of the sensors on board the adapter and one or more of the sensors off board the adapter. The energy assessment may be performed by the processor on board the adapter or the assessment may be performed at the server off board the adapter.

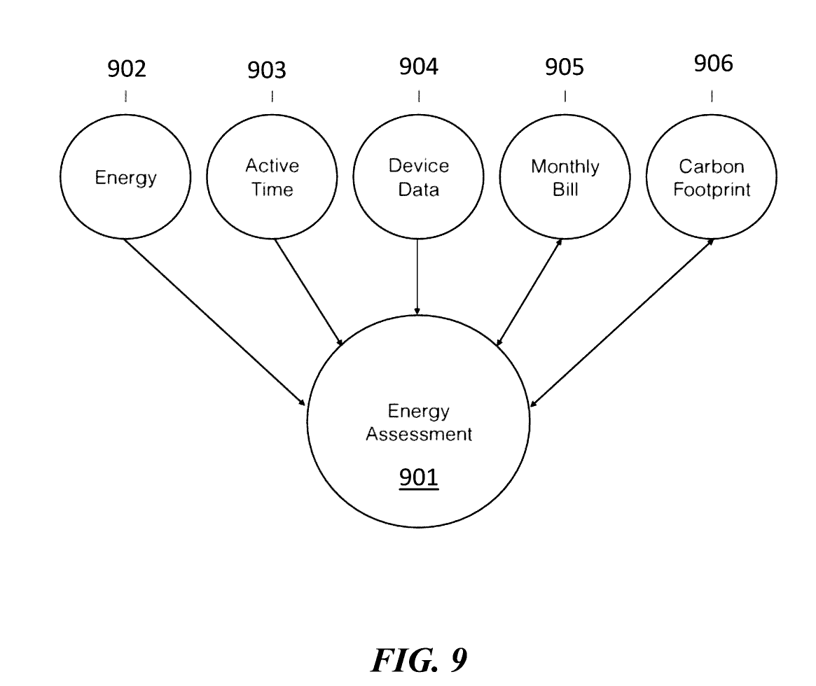

Inputs that can be provided to the energy assessment are shown in FIG. 9. Inputs to the energy assessment 901 can be one or more measurements provided by one or more sensors in communication with the adapter. The measurements can be quantifications of one or more characteristics of an environment surrounding the adapter. The measurements can describe the power usage of a device plugged in to the adapter. The power usage measurement 902 can include rate of power usage, voltage consumed by the device, current consumed by the device, or other characteristics of power usage. The power usage measurements can include the concentration of AC/DC power, such as in kilowatt hours. Power usage may be broadcast directly to an energy utility. An energy utility may in turn have the ability to adjust power usage automatically or manually. Another input to the energy assessment may be active time 903. Active time can be the time that a device in communication with the adapter has been functioning and/or operating. Active time can include time elapsed since the last time the device was turned off and from the beginning of installation. Another input to the energy assessment can be device data 904. The measurements from on board sensors a detector may further include information regarding the season, daytime, local weather, and/or a known calibration value. A known calibration value can be an expected sensor measurement. The expected sensor measurement can be based on a forecasting algorithm. The expected sensor measurement can be based on a typical average value. The calibration value can be stored in a database that can be accessed by the detector via the internet, for example a seasonal temperature and/or humidity average. Otherwise, a known calibration may come from historical baseline measurements performed by the environmental detector and stored on the storage device on board the detector or on the server. In another case, the known calibration may be defined by the user through the graphical user interface provided on an display of an electronic device. In an example, a known calibration may refer to a base line expected condition in an environment, for example, a baseline based on information from a database, historical measurement, or a user input. Based on the known calibration in the example, a sensor in a basement may experience higher levels of moisture detection than a sensor in an above ground environment.

Another input to the energy assessment can be a cost metric 905. A cost metric can be a monthly energy bill amount, an average monthly bill amount, a payment rate (e.g., $/KWhr), a maximum budgeted value set by a user, or a maximum consumption as regulated by a local or federal government. In some cases, the adapter can communicate with an energy service provider's billing records corresponding to the user of the adapter to track costs. In some cases, the adapter can communicate with an energy meter corresponding to the user of the adapter to track usage. The adapter can be in communication with a processor programmed to use data to project monthly bill costs. The data can include average usage data for a specific user, average usage data for users in a given demographic, and/or average usage data for a given location and/or season. The processor can monitor usage and transmit usage to an energy utility. The adapter can perform metering functions to provide usage data to an energy utility. In some cases, the adapter can control energy usage for cost optimization for the user and reduce the user's energy bill cost. In some cases, the adapter can decrease or limit usage during peak power times when a rate of energy cost increases.

In some cases, the adapter can be in communication with one or more processors programmed to estimate a user's total carbon footprint 906. A user's carbon footprint can be calculated on a daily, weekly, monthly, quarterly, or yearly basis. The carbon footprint can be calculated based on one or more inputs of the energy assessment in order to give an estimate of the environmental impact of the user's energy usage, as represented by carbon emissions and as measured in tons. In some cases, the user can provide additional data to the carbon footprint such as daily transportation use, garbage accumulation, and other carbon sources generated by the user. The user can provide the additional data through the graphical user interface provided on a display device in communication with the adapter.

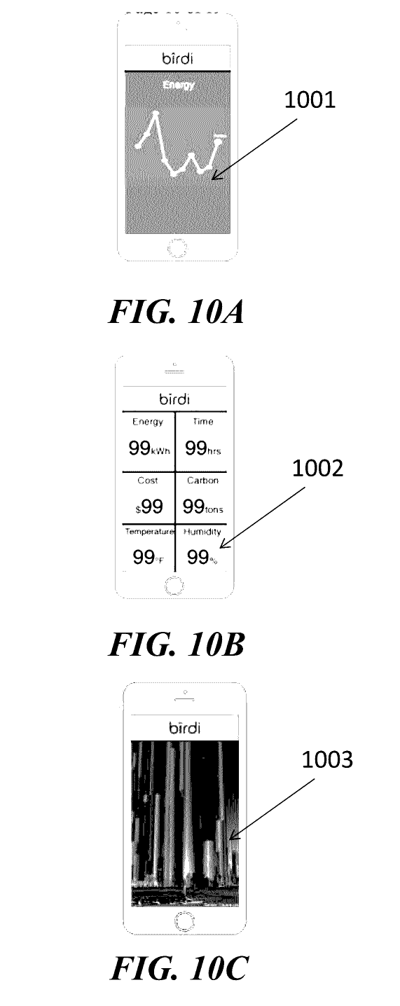

The one or more processors in communication with the adapter can be programmed to generate a visual representation of one or more sensor measurements for display on a graphical user interface. The sensor measurements can be shown as a function of an independent variable, for example time or location. FIG. 10A shows graphed time history of one or more sensor measurements 1001 for a specified time period, for example, the specified time period may be at least about 1 min, 30 min, 1 hour, 3 hours, 6 hours, 12 hours, 1 day, 1 week, 1 month, 1 quarter, or one year. One or more graphs can be displayed to a user on a graphical user interface provided on a display device. The graphs may depict sensor measurements and/or data associated with the energy assessment. In some cases, the measurements can be provided to the user to provide a characterization of an environment. The user can receive a quantitative assessment of the environment through the one or more graphs as opposed to a binary indicator that one or more conditions of the environment have crossed a threshold value. The graphs may be generated with a regular periodicity and sent a user's electronic device, alternatively the graphs may be sent on demand to a user's electronic device when a user requests a graphical summary of one or more sensor measurements. The graph may be transmitted to a user's electronic device directly from the adapter or it may be sent from the server off board the detector. A user may submit a request to the server from their electronic device for a graph of the sensor and energy measurements for a specified timer period. A user may choose to receive a graph of all sensor measurements or a graph of only a selection of one or more sensor measurements. A user may adjust the settings corresponding to the content and frequency of the graphed measurements from their electronic device. The graphs may be a time history of measurements from the sensors, one or more sensor measurements may be shown on the same graph. The graph may also provide a regression attempting to predict future sensor measurements.

FIG. 10B shows another display that can be provided on the graphical user interface 1002. The display can comprise numeric values that can be generated to describe on or more sensor measurements. The numeric values can be based on data from adapters in homes or buildings in alternate locations. FIG. 10C shows another display that can be provided on the graphical user interface 1004. The display can comprise a graphic showing a map of conditions 1003. The map can be a color-coded map where different colors correspond to difference sensor measurement ranges. The map can be a three-dimensional bar graph indicating sensor measurement values in different locations. The map can be based on data from adapters in homes or buildings in locations different from the location where a user is or lives.

The user interface of the electronic device may be configured to receive input from a user to monitor the function of the sensors and controls on board the adapter. The energy assessment may be displayed to a user through the user interface on the electronic device on demand. The electronic device can be in communication with a voltage sensor. The voltage sensor may monitor the voltage of the input and output of the adapter. The voltage sensor may detect fluctuations in voltage input to or output from the adapter. Fluctuations in voltage can be communicated to the user through the electronic device. In some cases, a voltage surge can be detected. When a voltage surge is detected the adapter can transmit a warning to a user indicating that there could be a problem such as an emergency. The warning can be communicated to a user through a phone call, text message, email, social media alert, or some combination of the listed alert mechanisms. In an embodiment in which the adapter is connected to a device that has a battery, the adapter can provide charge to the device. One or more sensors in communication with the adapter can track level of charge of one or more devices. When a device is fully charged and/or when the charge of the device exceeds a predetermined threshold value, the adapter can transmit an alert to the user to user to remove the device from a charging station.

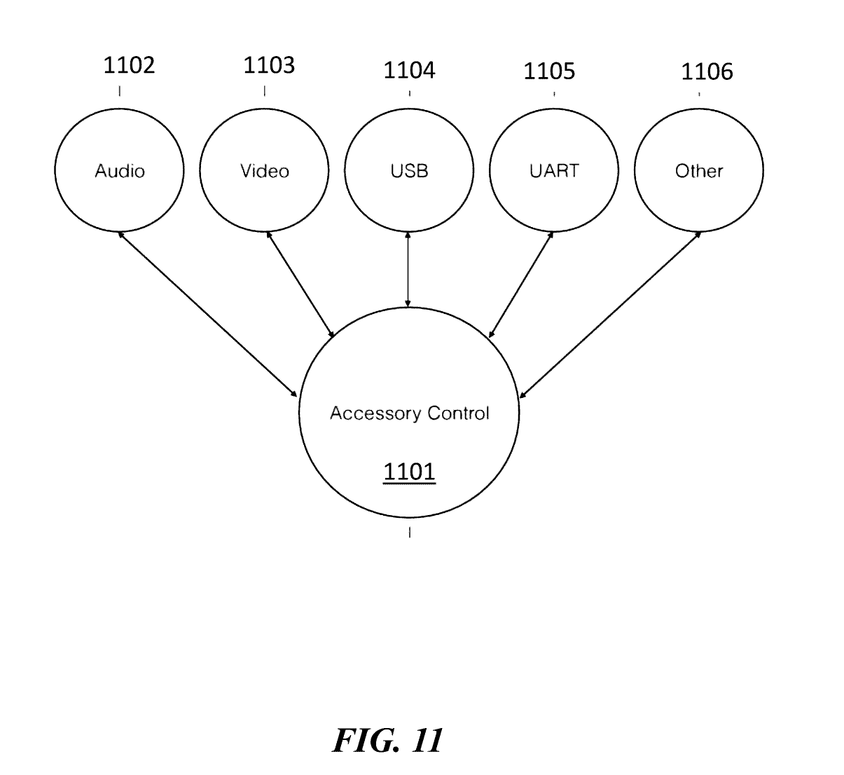

FIG. 11 shows functions of the inputs to accessory control by an adapter. The Connection, Communication, and Power Bus can have a variety of functions it for accessory control 1101. One function can be audio 1102. The audio function can include broadcasting sound. Sounds can be alarm sounds or verbal instructions. Another function can be providing a visual display such as a video 1103. The video function can provide control to an HDMI-enabled TV or display, for levels ranging up to 1080p at 60 Hz or UHD (3840×2160) at 30 Hz. The video function can output video content such as movies and captured video. The video output can have a resolution of Standard Definition or High Definition, including 4K. Another function can be provided through a USB connection 1104. Functions associated with the USB connection can control any version of Universal Serial Bus (USB), at any of Low, Full, High, Super, and Super+ Speeds and to any number of designated device classes. One such function is Universal asynchronous receiver/transmitter (UART) 1105, where it may control devices and transfer data including serial and parallel buses. Other Power Delivery 1106 can permit the adapter to send or receive up to 100 watts of electricity over a single connection while transmitting data at the same time.

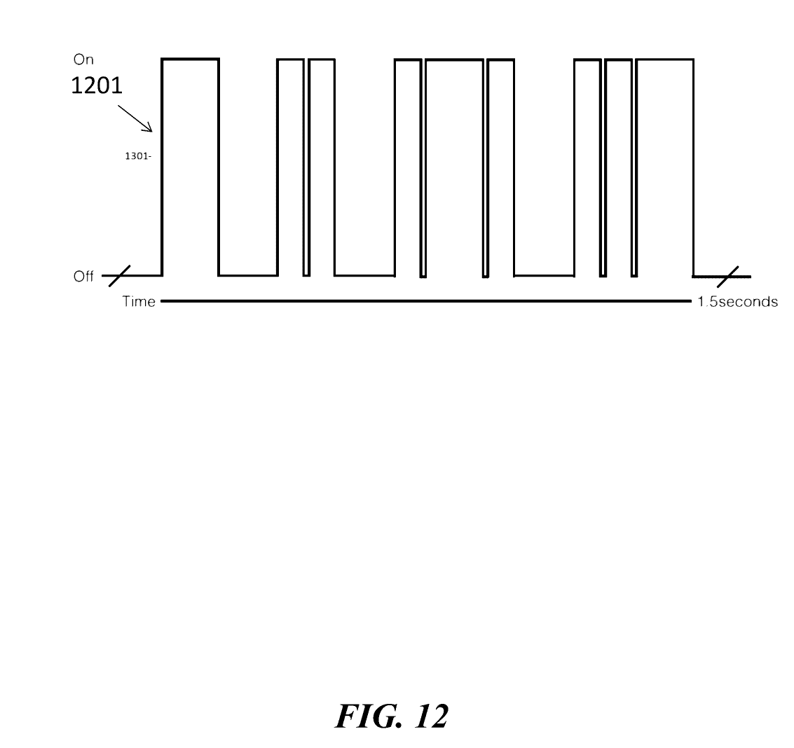

FIG. 12 shows an example of a signal that can be transmitted through the adapter. In some cases, the signal can be an alarm signal. The signal can be a weather emergency signal that can be broadcast to one or more devices in communication with the adapter. The signal can be a voltage signal. Signal 1201 can be a 9V DC (+/−2V) signal that is broadcast through a connected wire. The adapter can measure voltage fluctuation of the signal and pace of the signal to detect messages encoded by the signal. The adapter can transmit the signal and/or information obtained from the determination of one or more datum encoded by the signal to a connected device through a wired or wireless connection. This system also works in reverse such that the connected device can detect a condition and broadcast the signal through the adapter, which interprets the condition and broadcasts the state to one or more devices.

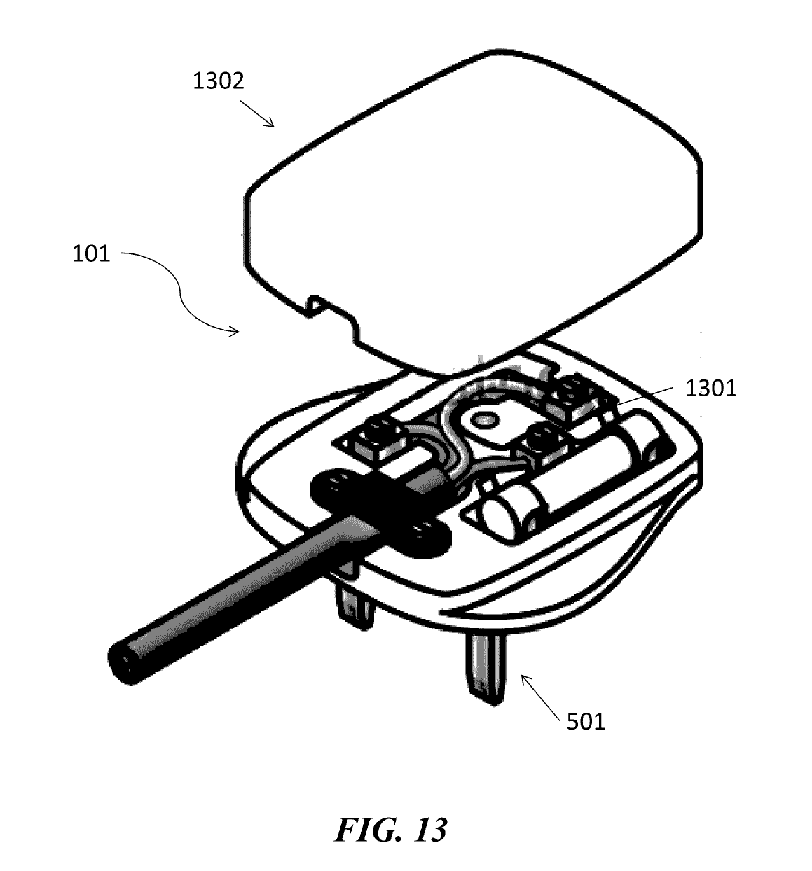

FIG. 13 shows an exploded view of the adapter 101. The adapter can comprise a housing that contains one or more sensors, processors, memory storage devices, amplifiers, signal transmitters, signal receivers, and/or other electrical components. The sensors, processors, and electrical components may be connected to a printed circuit board assembly (PCBA) 1301 fitted in the body 1302 of the adapter. An indicator light can be observable on an outer surface of the adapter by a user in a room or space with an installed adapter. An adapter may have one or more AC inputs 501. The AC inputs can be fixed prongs. The AC inputs can be available in different versions to match a variety of international electrical outlet standards from around the world and may have a inputs directly for power wires. An adapter may have a radio frequency (RF) module configured to transmit information. An adapter may have AC/DC input/outputs for a Connection, Communication, and Power Bus.

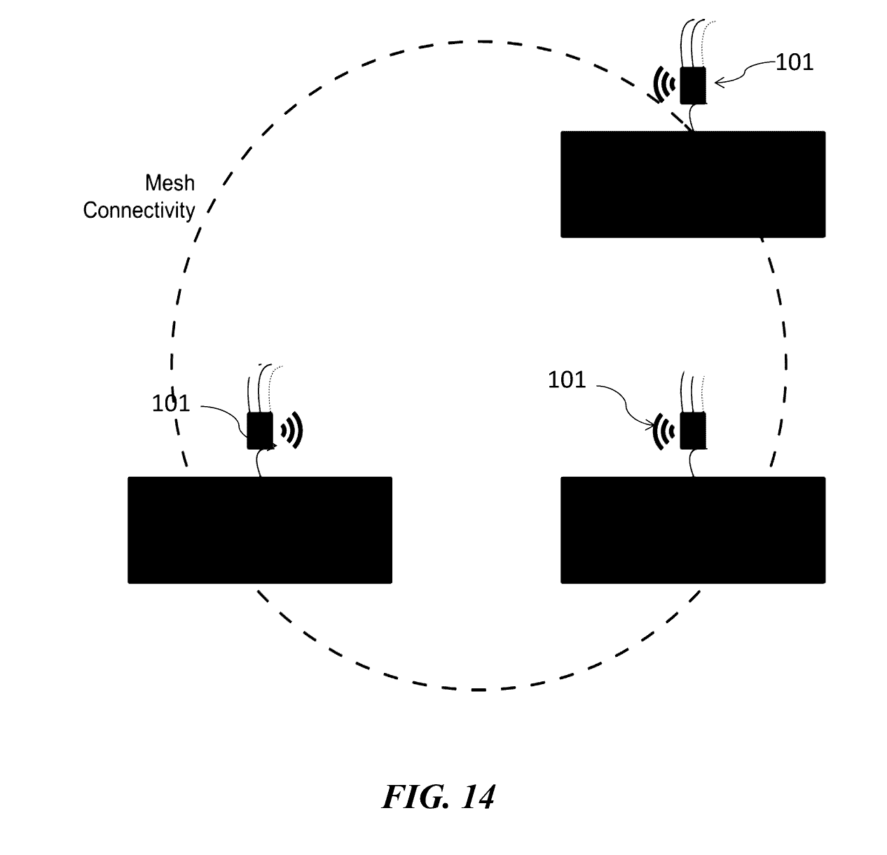

FIG. 14 shows an example of how two or more adapters 101 could communicate between additional connected devices in a smart building, such as a home by demonstrating a schematic of an example of overall connectivity of an adapter. One or more adapters can form a mesh network between adapters and connected to devices to form a possible radius to designate persons who may and may not receive a notification. Adapters 101 may connect to one another to communicate information and commands directly. In some cases, one or more adapters can function as repeaters to carry signals further, until connected to a network such as the internet and then broadcast.

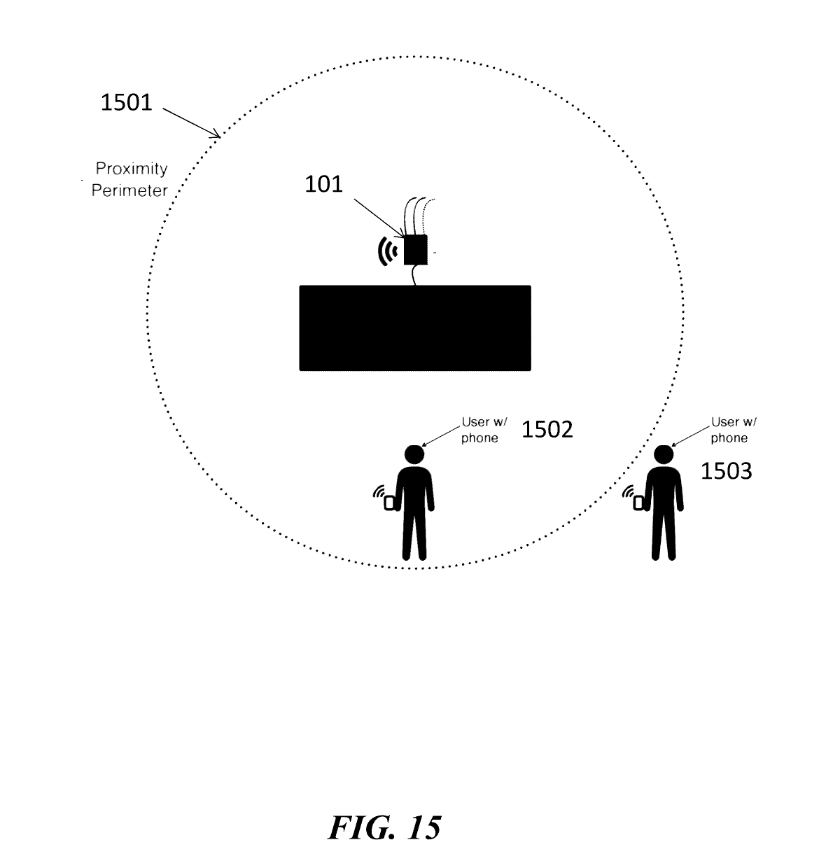

FIG. 15 shows an example of a possible radius 1501 to designate persons who may and may not receive a notification. The radius can contain one or more adapters which can transmit and/or receive signals comprising information. A Person 1502 may be inside the radius 1501 therefore they may receive a notifications transmitted from the adapter. Person 1503 may be outside of the radius and may therefore not receive a notification.

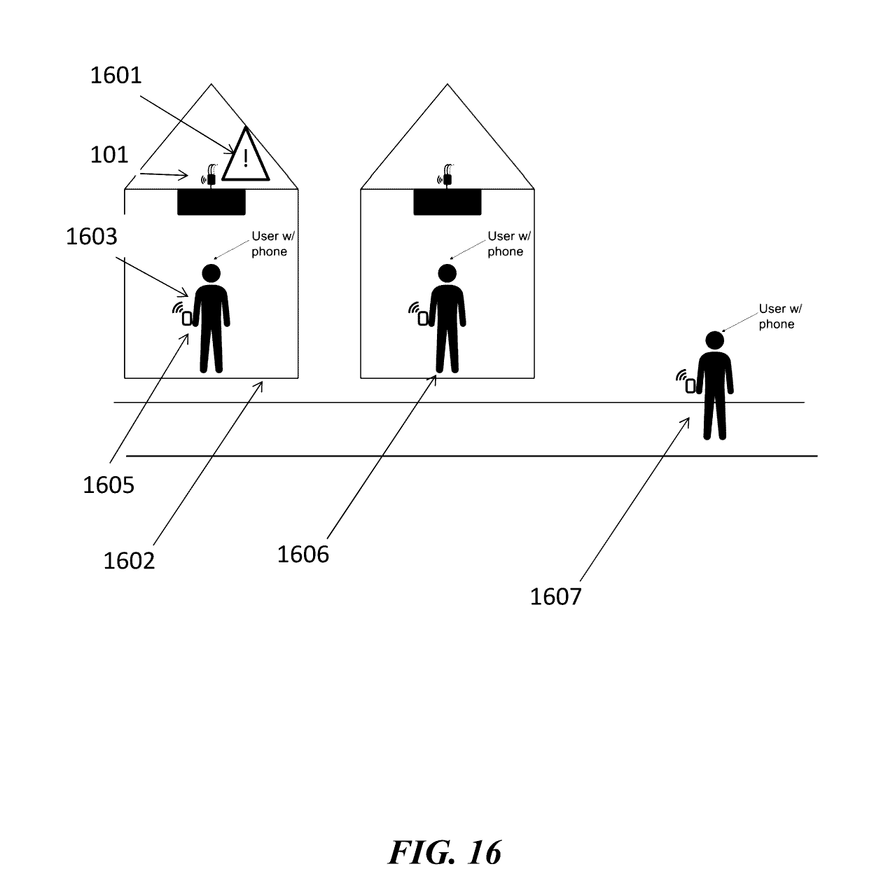

FIG. 16 shows an example of a detection of a hazard by an adapter and a subsequent response initiated by the server. A hazard, for example moisture 1601, may be detected by an adapter 101 in a building 1602 of a first user 1603. The first adapter 101 may send an alert to a server indicating the detected hazard. In response the server may send an alert message 1605 to an electronic device belonging to a first user. The server may also send an alert to a to an electronic device belonging to a nearby user 1606 that may also have an environmental detector installed in their home. The server may also send an alert to all users with the environmental detection interface downloaded on one or more electronic devices within a fixed geographic radius surrounding the first environmental detector which has detected a hazard. For example, the server may alert a user 1607 moving past the home in which a hazard has been detected. Notifying of users outside of a space of an environmental detector that has detected a hazard may create a community watch system such that authorities, neighbors, friends, and persons nearby a detected hazard can help to monitor and mitigate the detected hazard. An owner of a device may control who receives notifications from the environmental detector. The notification may include details of the hazard, or a characterization of an air space surrounding the detector, and options for a person receiving the notification to provide feedback, feedback may be confirming or denying the hazard. An owner may choose only to send notifications to a list of approved persons. Contact information from the approved persons may be synced with an address book stored on the electronic device, for example a contact list on a smart phone. An owner may control the geographic radius in which users may receive notifications from the environmental detector. An owner may also configure the environmental detector to contact security and/or health professionals in the case of a detected hazard.

In another case the server may mitigate the detected hazard. For example, if the detected hazard is an excessive moisture condition, which may be described as a detection of an amount of liquid above a preset threshold, the server may send and alert to a user instructing them to eliminate the source of moisture (e.g. a leak). Additionally, the processor on board the adapter may be instructed by the server to communicate with other devices in a space or building where a hazard is detected to mitigate the hazard. The processor may turn on a fan or ventilation system or turn off devices in the vicinity to mitigate the hazard. Alternatively or in addition to turning on a device to mitigate the detected hazard, a user may receive information through a call, text, email, or notification through the device software downloaded on an electronic device instructing them to mitigate the detected hazard. The information received may be an instruction to improve the hazard. In an example, the instruction may be to open or close a junction box, turn off an appliance, or re-orient a fan.

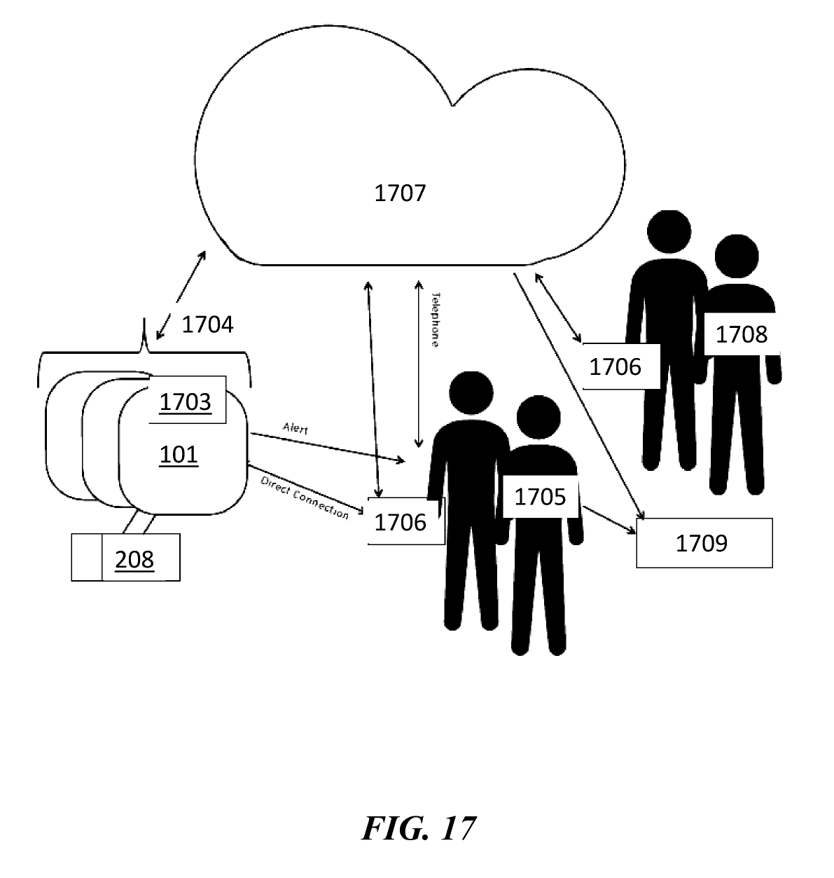

A graphic of a possible embodiment of the overall system architecture is shown in FIG. 17. One or more adapters 101 may be in communication with each other and also in communication with one or more devices 208. The connected adapters and other sensory devices may form a mesh 1704. The adapters may comprise a plurality of sensors 1703. The mesh may be in communication with responders or users 1705 through both physical alarms and direct connection to a software application on an electronic device 1706. The mesh 1704 may further communicate with a server 1707 through a CDMA/GSM handling server, a radio frequency (RF) router (such as WiFi, Bluetooth, Zigbee, etc.) or an internet connected smart device. The server 1707 may comprise connections to the server data base, telephony servers, push servers, and service authority servers. The server may communicate with the responders or users 1705 through a telephone or through a software application on an electronic device 1706. The server 1707 may also communicate with nearby persons 1708 through a software application on an electronic device 1706. The server 1707 may also communicate with emergency or non-emergency services 1709. The users or responders may also communicate with emergency or non-emergency services 1709.

### Control Systems

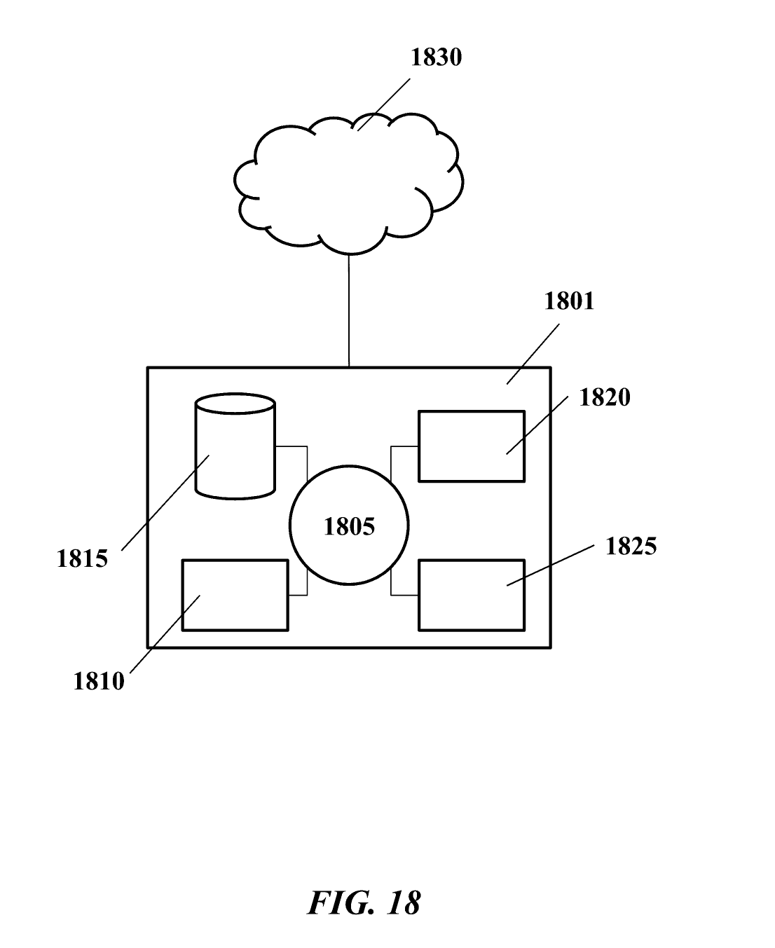

The present disclosure provides computer control systems that are programmed to implement methods of the disclosure. FIG. 18 shows a computer system 1801 that is programmed or otherwise configured to receive and transmit sensor data. The computer system can be further programmed to regulate various aspects of one or more devices provided in communication with the adapter. The computer system can regulate power consumption of one or more devices connected to an adapter.

The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC).

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1801 via the network 1830.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display that comprises a user interface (UI) for providing, for example, the user interface can display one or more graphical representation of one or more sensor measurements in real time or over a given historical period to a user. Examples of UI's include, without limitation, a graphical user interface (GUI) and web-based user interface.

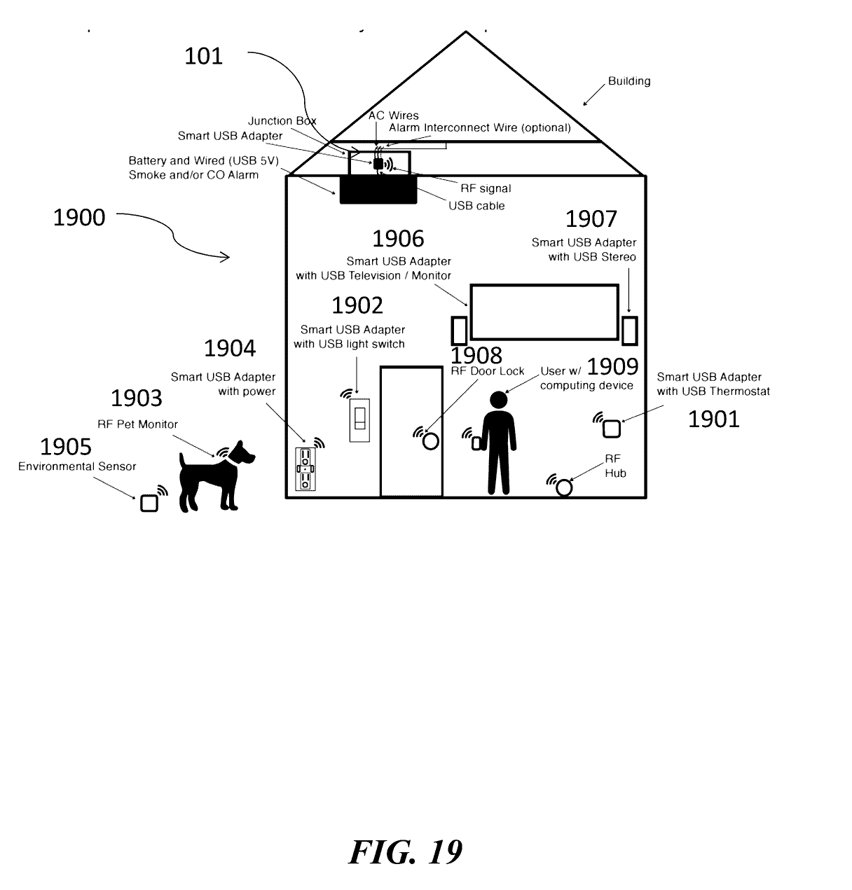

FIG. 19 shows a space 1900 with a network of adapters connected to a variety of devices. One or more devices in the space can be connected to a power source through an adapter. The adapter can monitor one or more states of the device. The adapter can monitor power usage of the device. One or more adapters in the space can communicate with other adapters in the space through direct signals such as RF signals. In some cases, one or more adapters in the space can communicate with other adapters in the space through a network that includes an external server. A thermostat 1901 can be connected to the adapter. The adapter can monitor thermostat settings, readings, and/or signals sent from the thermostat to a heating and/or cooling system for control of the heating and/or cooling system. An adapter can be connected to a light switch 1902 to monitor light usage. The adapter can automatically turn the lights one or off on a predetermined schedule. An adapter can be connected to a pet monitor 1903 such as a bark collar or a location tracking device to monitor movement, actions, or noise generated by the pet. An adapter can be connected to a wall outlet 1904. An adapter can be connected to an environmental sensor 1905 such as a smoke, humidity, moisture, or gas sensor. An adapter can be connected in a home entertainment system including a television 1906 and one or more speakers 1907. An adapter can be connected to a door lock 1908, for example and RF door lock. In some cases, an electronic device 1909 can be in communication with one or more adapters. The electronic device can be an electronic device comprising a display. The electronic device can provide a graphical user interface to a user on the display. The electronic device can be a smartphone, game system, television, tablet, laptop, desktop, other mobile personal computers, electronic medical devices, and/or wearable technology (e.g. smart watches or smart glasses). One or more of the adapters can communicate with the electronic device over a suitable network connection.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An adapter for providing electrical connectivity and network monitoring of an environment, the adapter comprising:
an interface for providing an electrical connection to one or more devices,
an electrical input configured to connect to a power source to transmit power through the adapter and convert the power from an initial power form to a converted power form that is usable by the one or more devices; and
one or more sensors configured to collect measurements to (1) monitor an environment surrounding the adapter and (2) monitor power usage of the converted power by the one or more devices.

2. The adapter of claim 1, wherein the power source emits 120V and/or 230V of AC power

3. The adapter of claim 1, wherein the power source emits 3V-5V+/− of DC power

4. The adapter of claim 1, wherein the measurements describe at least one of humidity, temperature, pressure, moisture, organisms, light, particulates and chemicals.

5. The adapter of claim 1, further comprising one or more communication modules configured to transmit and receive signals from one or more external devices.

6. The adapter of claim 5, wherein an external device is a user electronic device.

7. The adapter of claim 5, wherein an external device is a sensor.

8. The adapter of claim 5, wherein an external device is another adapter.

9. The adapter of claim 5, wherein an external device is a server.
